(19) United States
(12) Patent Application Publication
(10) Pub. No.: US 2022/0398867 A1
(43) Pub. Date: Dec. 15, 2022

(54) INFORMATION PROCESSING APPARATUS AND FACIAL EXPRESSION DETERMINATION METHOD

(71) Applicant: FUJITSU LIMITED, Kawasaki-shi (JP)

(72) Inventor: Akiyoshi UCHIDA, Akashi (JP)

(73) Assignee: FUJITSU LIMITED, Kawasaki-shi (JP)

(21) Appl. No.: 17/722,387

(22) Filed: Apr. 18, 2022

(30) Foreign Application Priority Data
Jun. 15, 2021 (JP) 2021-099500

(51) Int. Cl. G06V 40/16; G06T 7/246

(52) U.S. Cl. CPC G06V 40/176; G06T 7/248; G06V 40/171; G06T 2207/20081

(57) ABSTRACT

A non-transitory computer-readable recording medium stores a program causing a computer to execute a process including acquiring a taken image including a face with markers attached, determining whether a movement amount of a first marker in a first direction is equal to or greater than a first threshold, based on a first position of the first marker and criteria for an occurrence state of a facial muscle movement, determining whether a movement amount of a second marker in a second direction is less than a second threshold, based on a second position of the second marker and the criteria, determining that there is occurrence of the facial muscle movement upon determining that the movement amount of the first marker in the first direction is equal to or greater than the first threshold and the movement amount of the second marker in the second direction is less than the second threshold.

### CROSS-REFERENCE TO RELATED APPLICATION

This application is based upon and claims the benefit of priority of the prior Japanese Patent Application No. 2021-099500, filed on Jun. 15, 2021, the entire contents of which are incorporated herein by reference.

### FIELD

The embodiment discussed herein is related to a facial expression determination technology.

### BACKGROUND

Facial expressions play an important role in nonverbal communication. Facial expression estimation is an indispensable technology for developing a computer that understands and supports people. To estimate a facial expression, a method of describing the facial expression has to be specified first. Action units (AUs) are known as a method of describing facial expressions. The AU represents a facial movement involved in facial expression, as defined based on the anatomical findings of the facial muscles. There have also been proposed technologies for estimating AUs.

A representative form of an AU estimation engine that estimates AUs employs machine learning based on a large amount of training data, and image data of facial expressions as well as occurrence (occurrence or non-occurrence) and intensity (occurrence intensity) of each AU, which are obtained as a determination result of facial expression, are used as the training data. The occurrence and intensity of the training data are annotated by a specialist called a coder.

Japanese Laid-open Patent Publication No. 2018-036734, Japanese Laid-open Patent Publication No. 2020-057111, U.S. patent Ser. No. 10/339,369, and U.S. Patent Publication No. 2019/213403 are disclosed as related art.

### SUMMARY

According to an aspect of the embodiment, a non-transitory computer-readable recording medium stores a program causing a computer to execute a process, the process includes acquiring a taken image including a face with a plurality of markers attached, determining whether a movement amount of a first marker, among the plurality of markers, in a first direction is equal to or greater than a first threshold, based on a first position of the first marker in the taken image and criteria for an occurrence state of a first facial muscle movement, determining whether a movement amount of a second marker, among the plurality of markers, in a second direction is less than a second threshold, based on a second position of the second marker in the taken image and the criteria for the occurrence state of the first facial muscle movement, determining that there is occurrence as to an occurrence state of the first facial muscle movement upon determining that the movement amount of the first marker in the first direction is equal to or greater than the first threshold and the movement amount of the second marker in the second direction is less than the second threshold, and determining that there is no occurrence as to the occurrence state of the first facial muscle movement upon determining that the movement amount of the first marker in the first direction is equal to or greater than the first threshold and the movement amount of the second marker in the second direction is equal to or greater than the second threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a determination system according to an embodiment;

FIG. 2 is a diagram illustrating an example of camera arrangement according to the embodiment;

FIG. 3 is a diagram illustrating an example of marker movement according to the embodiment;

FIG. 4 is a diagram illustrating an example of a method of determining occurrence intensity according to the embodiment;

FIG. 5 is a diagram illustrating an example of a method of determining the occurrence intensity according to the embodiment;

FIG. 6 is a diagram illustrating an example of a movement vector with respect to a specified vector according to the embodiment;

FIG. 7 is a diagram illustrating an example of false detection of AU occurrence;

FIG. 8 is a diagram illustrating an example of a boundary and a region for AU determination;

FIG. 9 is a diagram illustrating an example of an AU determination result using a separation boundary according to the embodiment;

FIG. 10 is a block diagram illustrating a configuration example of a determination device according to the embodiment;

FIG. 11 is a diagram illustrating an example of a specified marker and a specified vector of an AU12 according to the embodiment;

FIG. 12 is a diagram illustrating an example of a cancel marker and a cancel vector of the AU12 according to the embodiment;

FIG. 13 is a diagram illustrating an example of a movement vector upon occurrence of the AU12 according to the embodiment;

FIG. 14 is a diagram illustrating an example of a movement vector when the AU12 occurrence is cancelled according to the embodiment;

FIG. 15 is a diagram illustrating an example of a movement vector upon occurrence of an AU09 according to the embodiment;

FIG. 16 is a diagram illustrating an example of a movement vector when the AU09 occurrence is cancelled according to the embodiment;

FIG. 17 is a diagram illustrating an example of a mask image generation method for removing markers according to the embodiment;

FIG. 18 is a diagram illustrating an example of a marker removal method according to the embodiment;

FIG. 19 is a flowchart illustrating an example of a determination processing according to the embodiment; and

FIG. 20 is a diagram illustrating a hardware configuration example of the determination device according to the embodiment.

### DESCRIPTION OF EMBODIMENT

The existing method has a problem that it may be difficult to generate training data for facial expression estimation. For example, annotation by a coder is costly and time-consuming, thus making it difficult to create large amounts of data. It is also difficult to accurately capture small changes in movement measurement of each part of a face by image processing of a face image, and it is difficult for a computer to determine a facial expression from the face image without human judgment.

Hereinafter, examples according to the embodiment will be described in detail based on the drawings. The examples do not limit the present embodiment. The embodiment will be described by way of example, but is not limited to AU.

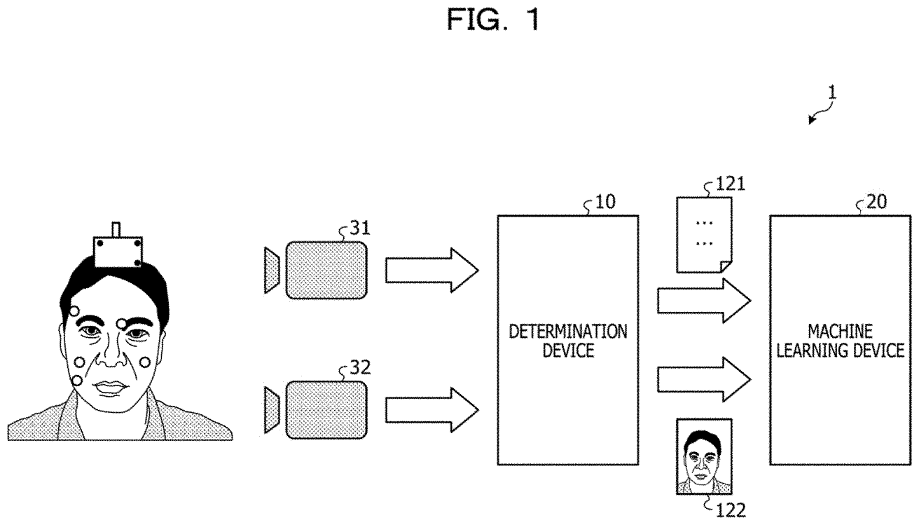

A configuration of a determination system according to the present embodiment will be described with reference to FIG. 1. FIG. 1 is a diagram illustrating a configuration example of a determination system according to the present embodiment. As illustrated in FIG. 1, a determination system 1 includes a red-green-blue (RGB) camera 31, an infrared (IR) camera 32, a determination device 10, and a machine learning device 20.

As illustrated in FIG. 1, first, the RGB camera 31 and the IR camera 32 are directed to the face of a person with markers. For example, the RGB camera 31 is a general digital camera, which receives visible light to generate an image. For example, the IR camera 32 senses infrared rays. The markers are, for example, IR reflection (retroreflection) markers. The IR camera 32 may perform motion capture by utilizing the IR reflection by the markers. In the following description, the person to be imaged is referred to as a subject.

The determination device 10 acquires the image taken by the RGB camera 31 and the result of motion capture by the IR camera 32. The determination device 10 determines an occurrence intensity 121 of an AU, and outputs the occurrence intensity 121 and an image 122 obtained by removing the markers through image processing from the taken image to the machine learning device 20. For example, the occurrence intensity 121 may be data that is expressed using a 6-level rating system with a scale from 0 to 5 for each AU, and is annotated such as “AU1: 2, AU2: 5, AU4: 0, . . . ”. The occurrence intensity 121 may be data that is expressed using 0 for no occurrence and a 5-level rating system with a scale from A to E for each AU, and is annotated such as “AU1: B, AU2: E, AU4: 0, . . . ”. The occurrence intensity is not limited to that expressed using such a 6-level rating system, and may be expressed based on, for example, 2-level evaluation (occurrence or non-occurrence).

The machine learning device 20 performs machine learning using the image 122 and the AU occurrence intensity 121 outputted from the determination device 10 as training data, and generates a machine learning model for calculating an estimated value of the AU occurrence intensity from the image. The machine learning device 20 may use the AU occurrence intensity as a label. The processing performed by the machine learning device 20 may be performed by the determination device 10. In this case, the machine learning device 20 does not have to be included in the determination system 1.

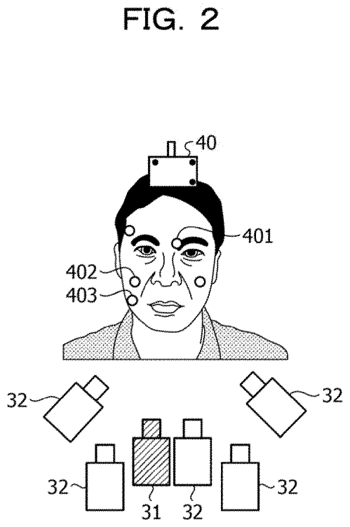

Arrangement of cameras will be described with reference to FIG. 2, FIG. 2 is a diagram illustrating an example of the arrangement of cameras according to the present embodiment. As illustrated in FIG. 2, a plurality of IR cameras 32 may be included in a marker tracking system. In that case, the marker tracking system may detect the positions of IR reflection markers by stereo imaging. It is assumed that the relative positional relationship between each of the plurality of IR cameras 32 is corrected by camera calibration.

A plurality of markers are attached to the face of the subject to be imaged so as to cover target AUs (for example, AU1 to AU28). The positions of the markers change with changes in the facial expression of the subject. For example, a marker 401 is arranged near the base of the eyebrow. A marker 402 and a marker 403 are arranged near the marionette lines. The markers may be placed on the skin corresponding to the movement of one or more AUs and facial muscles. The markers may be arranged so as to avoid the surface of the skin where the texture changes significantly due to wrinkles or the like.

The subject wears an instrument 40 with a reference marker. It is assumed that the position of the reference marker attached to the instrument 40 does not change even if the facial expression of the subject changes, Therefore, the determination device 10 may detect changes in the positions of the markers attached to the face based on a change in position relative to the reference marker. The determination device 10 may also identify the coordinates on a plane or space of each marker based on the positional relationship with the reference marker. The determination device 10 may determine the marker positions from a reference coordinate system or a projection position of a reference plane. By setting the number of the reference markers to three or more, the determination device 10 may identify the marker positions in a three-dimensional space.

The instrument 40 is, for example, a headband, and the reference marker is placed outside the contour of the face. The instrument 40 may be a VR headset, a mask made of a hard material, or the like. In that case, the determination device 10 may use a rigid surface of the instrument 40 as the reference marker.

The determination device 10 determines whether or not each of a plurality of AUs has occurred, based on AU criteria and the positions of the plurality of markers. The determination device 10 also determines the occurrence intensity for one or more AUs determined to have occurred among the plurality of AUs.

For example, the determination device 10 determines an occurrence intensity of a first AU based on a movement amount of a first marker that is included in the criteria and substantially moves when the first AU has occurred. The movement amount of the first marker is calculated based on the distance between a reference position of the first marker and the position of the first marker. The first marker may be said to be one or a plurality of markers corresponding to a specific AU. The first marker may be a marker used to determine the occurrence and occurrence intensity of AU, and a marker used only to determine the occurrence of AU without affecting the occurrence intensity of AU. In this case, when both of the marker used to determine the occurrence and occurrence intensity of AU and the marker used only to determine the occurrence of AU without affecting the occurrence intensity of AU have movements of a threshold or more, it may be determined that the AU has occurred. The AU occurrence intensity may be determined based only on the amount of movement of the marker used to determine the AU occurrence and occurrence intensity.

The AU criteria indicate, for example, one or more markers used to determine the AU occurrence intensity for each AU, among the plurality of markers. The AU criteria may include reference positions of the plurality of markers. The AU criteria may include a relationship (conversion rule) between the occurrence intensity and the movement amount of the marker used to determine the occurrence intensity for each of the plurality of AUs. The reference position of the marker may be determined according to each position of the plurality of markers in the taken image of the subject in an expressionless state (no AUs have occurred).

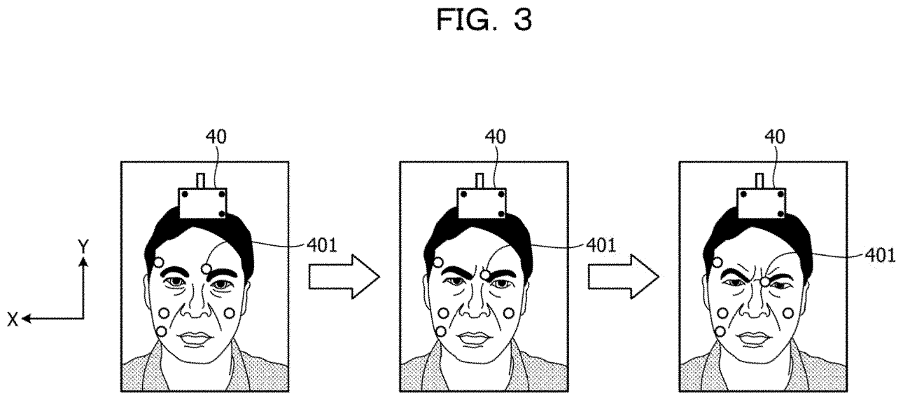

The movement of the marker will be described with reference to FIG. 3. FIG. 3 is a diagram illustrating an example of marker movement according to the present embodiment. Images on the left, in the middle, and on the right of FIG. 3 are images taken by the RGB camera 31. It is assumed that the images illustrated in FIG. 3 are taken in the order of the one on the left, the one in the middle, and the one on the right. For example, the image illustrated on the left of FIG. 3 is taken when the subject is expressionless. The determination device 10 may regard the position of the marker in the image on the left of FIG. 3 as the reference position where the movement amount is 0.

As illustrated in FIG. 3, the subject has a facial expression where he/she draws his/her eyebrows together. In this event, the position of the marker 401 moves downward with the change in facial expression. Upon this movement, the distance between the position of the marker 401 and the reference marker attached to the instrument 40 is increased.

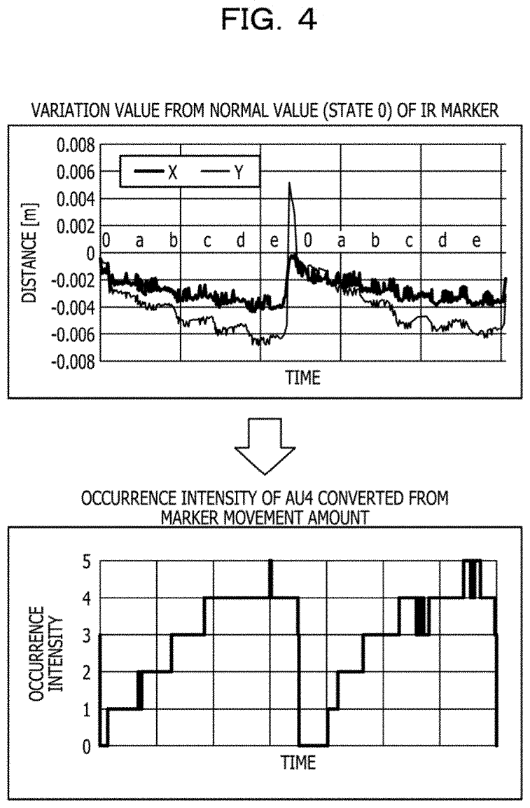

FIG. 4 illustrates variation values of the distance in an X direction and a Y direction between the marker 401 and the reference marker. FIG. 4 is a diagram illustrating an example of a method of determining the occurrence intensity according to the present embodiment. As illustrated in FIG. 4, the determination device 10 may convert the variation value of the distance in the X and Y directions between the marker 401 and the reference marker into the occurrence intensity. The occurrence intensity may be quantized in five levels according to a facial action coding system (FACS), or may be defined as a continuous quantity based on a variation.

Various rules are conceivable for the determination device 10 to convert the variation into the occurrence intensity. The determination device 10 may perform conversion according to one predetermined rule, or may perform conversion according to a plurality of rules and adopt the one with the highest occurrence intensity.

For example, the determination, device 10 may acquire the maximum variation, which is the variation when the subject changes the facial expression to the maximum, and convert the variation into the occurrence intensity based on a ratio of the variation to the maximum variation. The determination device 10 may determine the maximum variation using data tagged by the coder with an existing method. The determination device 10 may linearly convert the variation into the occurrence intensity. The determination device 10 may perform conversion using an approximate expression created from the preliminary measurement of a plurality of subjects.

For example, the determination device 10 may determine the occurrence intensity based on a movement vector of the first marker calculated based on the position set as the criteria and the position of the first marker. In this case, the determination device 10 determines the occurrence intensity of the first AU based on the degree of matching between the movement vector of the first marker and a specified vector associated with the first AU. The determination device 10 may use an existing AU estimation engine to correct the correspondence between the magnitude of the vector and the occurrence intensity.

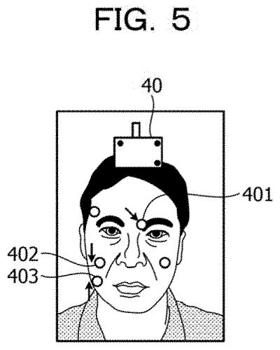

The method of determining the occurrence intensity of AU will be described more specifically. FIG. 5 is a diagram illustrating an example of a method of determining the occurrence intensity according to the present embodiment. For example, it is assumed that a specified vector corresponding to AU4 is defined as (X, Y)=(−2 mm, −6 mm). In this event, the determination device 10 calculates the inner product of the movement vector of the marker 401 and the specified vector, and normalizes the inner product with the size of the specified vector. When the inner product matches the magnitude of the specified vector of AU4, the determination device 10 determines that the AU4 occurrence intensity is 5 on a scale of 1 to 5, On the other hand, when the inner product is half the specified vector of AU4, in the case of the linear conversion rule described above, for example, the determination device 10 determines that the AU4 occurrence intensity is 3 on a scale of 1 to 5.

In FIG. 5, for example, it is assumed that the magnitude of the specified vector corresponding to AU11 is defined as 3 mm. In this event, when the variation in the distance between the markers 402 and 403 matches the magnitude of the specified vector of AU11, the determination device 10 determines that the AU11 occurrence intensity is 5 on a scale of 1 to 5. On the other hand, when the variation in the distance is half the specified vector of AU11, in the case of the linear conversion rule described above, for example, the determination device 10 determines that the AU11 occurrence intensity is 3 on a scale of 1 to 5. As described above, the determination device 10 may also determine the occurrence intensity based on a change in the distance between the position of the first marker and the position of the second marker.

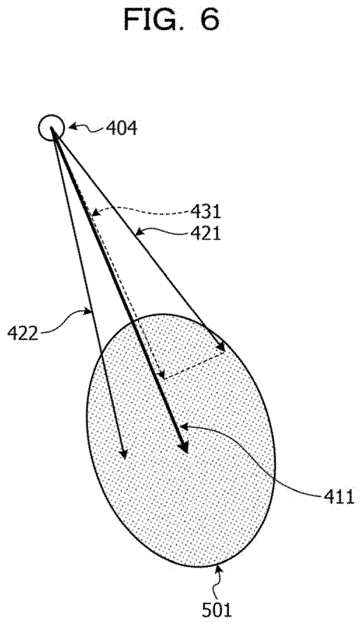

There is the case that the movement vector of each marker may be dispersed, and may not completely match the determination direction of the specified vector. FIG. 6 is a diagram illustrating an example of movement vectors with respect to a specified vector according to the present embodiment. In the example of FIG. 6, a specified vector 411 of AU4 associated with a marker 404 and movement vectors 421 and 422 of the marker 404 are illustrated.

As illustrated in FIG. 6, for example, there is a deviation in directions indicated by the movement vectors 421 and 422 of the marker 404 with respect to the specified vector 411 of AU4. This is merely an example, but the movement vectors of the marker 404 may be thus dispersed within a dispersion range 501.

However, even if the movement vectors are dispersed, the occurrence intensity of the AU corresponding to the specified vector may be determined by calculating the inner product of the movement vector and the specified vector. In FIG. 6, an inner product 431 is the inner product of the movement vector 421 and the specified vector 411. As specifically described with reference to FIG. 5, the occurrence intensity of AU4 corresponding to the specified vector 411 may be determined based on the inner product 431. In FIG. 6, the inner product 431 is illustrated slightly offset from the specified vector 411 for convenience, but both actually overlap.

As described above, the AU occurrence intensity may be determined based on the inner product of the specified vector and the movement vector of AU and the variation in the distance between markers. However, a marker that substantially moves when the target AU occurs may move in response to another facial expression, for example, upon occurrence of another AU even when the target. AU has not occurred. Therefore, the occurrence of AU that has not actually occurred may be falsely detected.

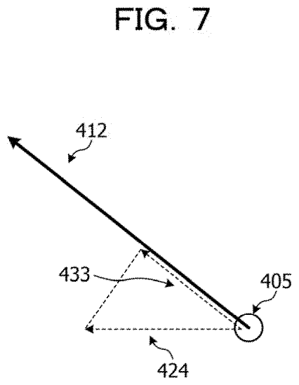

FIG. 7 is a diagram illustrating an example of false detection of AU occurrence. The example of FIG. 7 illustrates that a marker 405, which substantially moves when AU12 occurs, moves due to the movement of the facial muscles upon occurrence of AU20, and that a movement vector 424 is generated. When the movement vector 424 is generated, the determination device 10 calculates an inner product 433 of a specified vector 412 of AU12 with respect to the marker 405 and the movement vector 424 to determine the occurrence intensity, thus leading to false detection of the occurrence of AU12, which has not actually occurred.

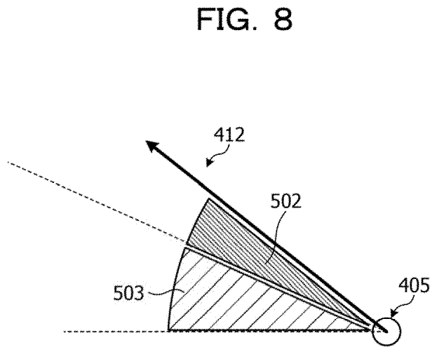

In order to avoid such false detection of AU occurrence, it is attempted to determine the AU based on a region including the movement vector by providing a separation boundary in the vector space, for example. FIG. 8 is a diagram illustrating an example of boundaries and regions for AU determination. As illustrated in FIG. 8, the marker 405 associated with the AU12 is provided with a boundary so as to have divided determination regions 502 and 503, The determination device 10 determines that the AU12 has occurred when the movement vector is included in the determination region 502, and that the AU12 has not occurred when the movement vector is included in the determination region 503.

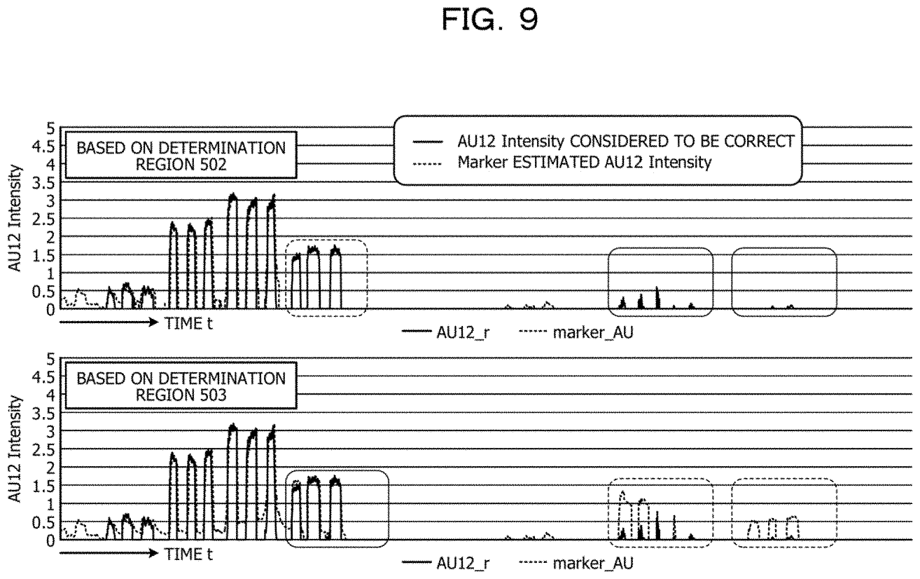

FIG. 9 is a diagram illustrating an example of an AU determination result using the separation boundary according to the present embodiment. FIG. 9 illustrates the determination result of the occurrence intensity of AU12 when the facial expression goes through various changes with time. The upper graph and the lower graph represent the determination result with the determination region 502 and the determination result with the determination region 503, respectively. The AU12 occurrence intensity, which seems to be the correct answer, is superimposed on each graph.

When referring to the determination result of FIG. 9, there is a large error from the correct answer in the determination result of the portion illustrated within the dashed frame, and even if the separation boundary is shifted to adjust the ranges of the determination regions 502 and 503, any of such errors still remains. There is a possibility that a new large error will occur. Therefore, there is the case that it is difficult to perform adequate detection of the target AU based on the determination using the separation boundary for the target AU, or the determination using only the movement of the marker that substantially moves when the target AU as illustrated in FIG. 7 occurs.

Therefore, in the present embodiment, in order to determine the target AU, the AU determination is made based on not only the movement of the marker that substantially moves when the target AU occurs, but also the movement of other markers.

### Functional Configuration of Determination Device

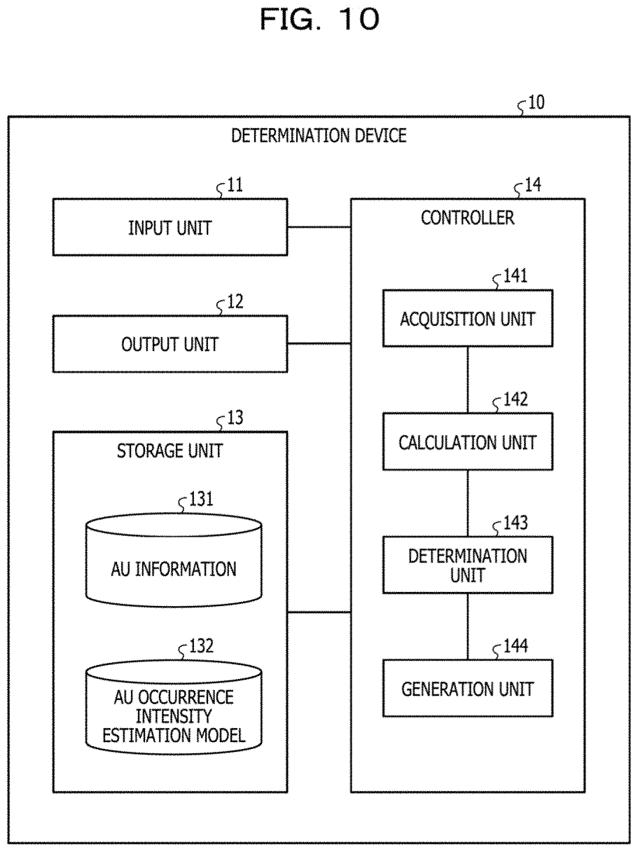

A functional configuration of the determination device 10 according to the present embodiment will be described with reference to FIG. 10. FIG. 10 is a block diagram illustrating a configuration example of the determination device according to the present embodiment. As illustrated in FIG. 10, the determination device 10 includes an input unit 11, an output unit 12, a storage unit 13, and a controller 14.

The input unit 11 receives data input via an input device such as the RGB camera 31, the IR camera 32, a mouse, and a keyboard, for example. For example, the input unit 11 receives an image taken by the RGB camera 31 and the result of motion capture by the IR camera 32. The output unit 12 outputs data to an output device such as a display, for example. For example, the output unit 12 outputs the occurrence intensity 121 of AU and the image 122 obtained by removing markers through image processing from the taken image.

The storage unit 13 has a function to store data, programs to be executed by the controller 14, and the like, and is implemented by a storage device such as a hard disk or a memory, for example. The storage unit 13 stores AU information 131 and an AU occurrence intensity estimation model 132.

The AU information 131 represents the correspondence between markers and AUs. For example, a reference position of each marker, one or more AUs corresponding to each marker, and the direction and magnitude of a specified vector of each AU are stored in association with each other.

The AU occurrence intensity estimation model 132 is a machine learning model generated by machine learning with the taken image, from which the markers are removed, as a feature amount and the AU occurrence intensity as a correct label.

The controller 14 is a processing unit that controls the entire determination device 10, and includes an acquisition unit 141, a calculation unit 142, a determination unit 143, and a generation unit 144.

The acquisition unit 141 acquires the taken image including a face. For example, the acquisition unit 141 acquires a group of continuously taken images including the face of a subject with markers attached at a plurality of reference positions corresponding to the plurality of AUs. The taken images acquired by the acquisition unit 141 are taken by the RGB camera 31 and the IR camera 32 as described above.

The subject changes his/her facial expressions as the images are taken by the RGB camera 31 and the IR camera 32. In this event, the subject may freely change the facial expressions, or may change the facial expressions according to a predetermined scenario. As a result, the RGB camera 31 and the IR camera 32 may take images of how the facial expressions change in chronological order. The RGB camera 31 may also shoot a video. For example, the video may be regarded as a plurality of still images arranged in chronological order.

The calculation unit 142 calculates a movement vector based on the positions of the markers included in the taken image. For example, the calculation unit 142 derives a movement amount and a movement direction of the markers moved by the change in the facial expression of the subject from the reference positions of the markers in the taken image. The calculation unit 142 calculates an inner product of the movement vector and the specified vector indicating the AU determination direction.

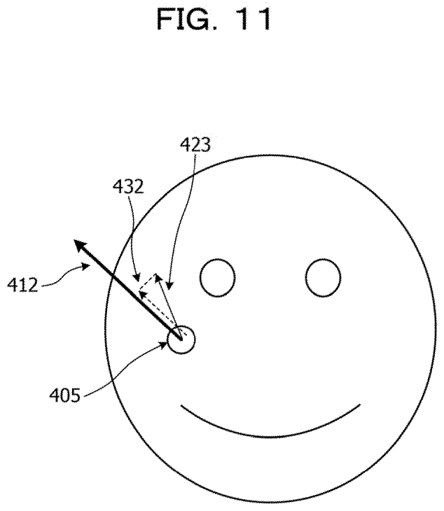

As described above, the determination unit 143 determines the occurrence intensity of the AU corresponding to each of the specified vectors based on each specified vector. The determination unit 143 may also determine whether or not AU has occurred, based on not only the occurrence intensity but also whether the movement amount of the marker indicated by the movement vector or the inner product of the movement vector and the specified vector exceeds a predetermined threshold. Regarding this point, description will be given by giving a specific example with reference to FIG. 11.

FIG. 11 is a diagram illustrating an example of a specified marker and a specified vector of AU 12 according to the present embodiment. As illustrated in FIG. 11, the determination unit 143 determines the occurrence intensity of the AU12 based on how much an inner product 432 of a movement vector 423 of the marker 405 associated with the AU12 and the specified vector 412 of the AU12 exceeds a predetermined threshold.

As described above, there may be a case where the determination of the target AU is not performed properly only with the movement of the marker that substantially moves when the target AU occurs. Therefore, the determination unit 143 performs determination of the target AU based on the movement of not only a marker that substantially moves when the target AU has occurred, but also a marker other than that marker (which may be hereinafter referred to as a “cancel marker”). For example, as will be described specifically later, the determination unit 143 determines whether or not the target AU has occurred, based on the movement of the cancel marker.

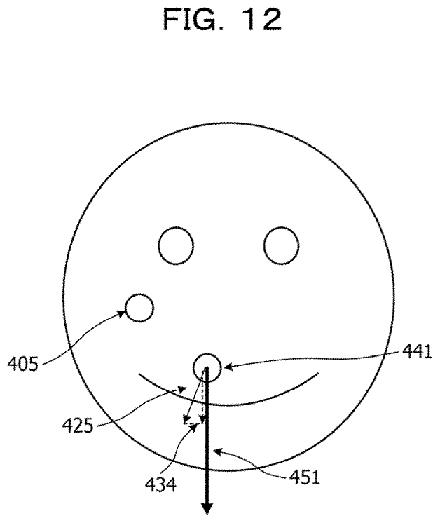

FIG. 12 is a diagram illustrating an example of a cancel marker and a cancel vector of the AU 12 according to the present embodiment. FIG. 12 illustrates a cancel marker 441 other than the marker 405 that substantially moves when the AU 12 has occurred. In the case of the cancel marker 441, again, an inner product 434 of a movement vector 425 of the cancel marker 441 and a cancel vector 451 that specifies the cancellation of occurrence of the AU 12 is calculated as in the case of the AU specified marker. The determination unit 143 determines that the AU12 has not occurred, when the inner product 434 is equal to or greater than a predetermined threshold, for example. This means that it is determined that the AU12 has not occurred, for example, even when it has been determined, based on the movement of the marker 405 associated with the AU12, that the occurrence intensity of the AU12 is 1 or more and that the AU12 has occurred. In this case, the determination unit 143 may set the occurrence intensity of the AU12 to 0.

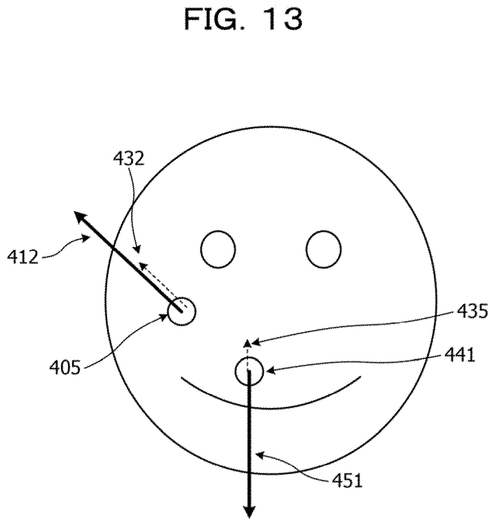

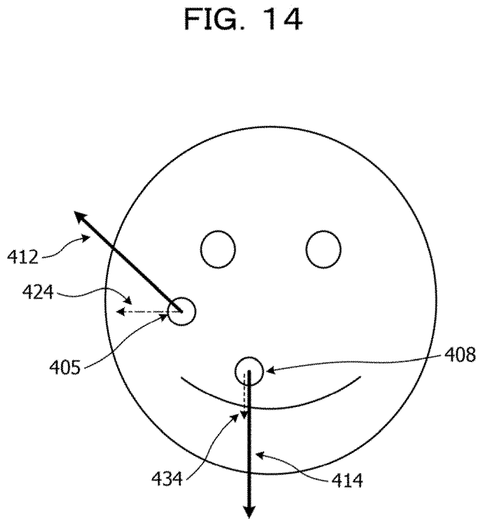

The AU determination using the cancel marker will be described more specifically with reference to FIGS. 13 and 14. FIG. 13 is a diagram illustrating an example of a movement vector upon occurrence of the AU12 according to the present embodiment. The AU12 is an AU that occurs when the subject smiles, and the example of FIG. 13 illustrates the movement of the marker 405 that substantially moves upon occurrence of the AU12 when the subject smiles and the movement of the cancel marker 441 of the AU12.

In the example of FIG. 13, since the inner product 432 of the specified vector 412 and a movement vector generated by the movement of the marker 405 is equal to or greater than a predetermined threshold, the determination unit 143 determines that the AU12 has occurred. On the other hand, an inner product 435 of the cancel vector 451 and a movement vector generated by the movement of the cancel marker 441 is generated in the direction opposite to the cancel vector 451, and thus the inner product 435 is 0. In this case, since the movement of the cancel marker 441 that cancels the occurrence of the AU12 has not occurred, the determination unit 143 maintains the determination result based on the movement of the marker 405, for example, the determination result that the AU12 has occurred.

Although FIG. 13 illustrates an extreme example of the movement of the cancel marker 441 for the sake of easy understanding of the explanation, there may also be a case where there is almost no movement of the cancel marker 441 upon occurrence of the AU12. Although FIG. 13 illustrates the case where the inner product 435 is 0, the determination unit 143 may determine that there is no such movement of the cancel marker 441 as to cancel the occurrence of the AU12 when the inner product 435 is less than a predetermined threshold, for example.

Next, an example in a case of canceling the occurrence of the AU12 will be described. FIG. 14 is a diagram illustrating an example of a movement vector when the occurrence of the AU12 is cancelled according to the present embodiment. In the example of FIG. 14, the movements of the marker 405 which substantially move upon occurrence of the AU12 and a marker 408 when the subject makes a facial expression such as pressing the lips or pulling the corners of the mouth outward. An AU16 occurs when the subject has the facial expression of pressing the lips, and an AU20 occurs when the facial expression of pulling the corners of the mouth outward, leading to the correct determination result, in either case, that the AU12 has not occurred.

First, in the example of FIG. 14, again, since the inner product of the movement vector 424 of the marker 405 and the specified vector 412 is equal to or greater than the predetermined threshold, the determination unit 143 determines that the AU12 has occurred. However, since the inner product 434 of the specified vector 414 and a movement vector generated by the movement of the marker 408 is also equal to or greater than the predetermined threshold, the determination unit 143 determines that the AU12 has not occurred. Since the movement amount of the marker for each facial expression and the size of the face differ depending on the subject, each threshold may be determined, for example, based on the position of each marker during an expressionless state for each subject. Two or more cancel markers may be set for a specific AU. When two or more cancel markers are set for a specific AU, it may be determined that no specific AU has occurred if at least one cancel marker is equal to or greater than the threshold. Alternatively, it may be determined that no specific AU has occurred if all the cancel markers set for the specific AU are equal to or greater than the threshold.

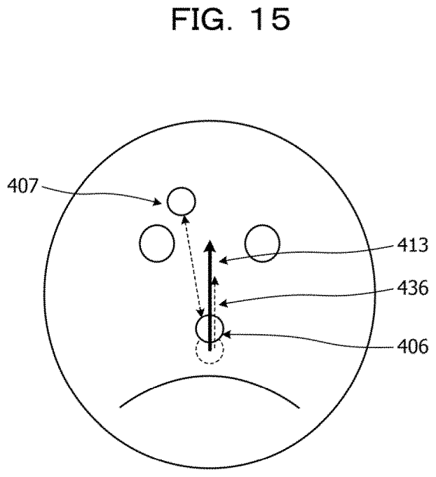

Although the AU determination using the cancel marker has been described with reference to FIGS. 13 and 14, AU determination based on a distance between markers will also be specifically described next. FIG. 15 is a diagram illustrating an example of a movement vector upon occurrence of the AU09 according to the present embodiment. The AU09 is an AU that occurs when the subject frowns, and the example of FIG. 15 illustrates the movement of a marker 406 associated with the AU09 and another marker 407 when the subject frowns.

In the example of FIG. 15, since an inner product 436 of a specified vector 413 and a movement vector generated by the movement of the marker 406 is equal to or greater than a predetermined threshold, the determination unit 143 determines that the AU09 has occurred. Since the distance between the markers 406 and 407 is reduced as the marker 406 has moved, compared with that during the expressionless state, the determination unit 143 maintains the determination result based on the movement of the marker 406, for example, the determination result that the AU09 has occurred.

When a predetermined threshold is set for the determination of the distance between the markers 406 and 407 and the distance between the markers becomes equal to or lower than the threshold, the determination unit 143 may determine that the distance between the markers is reduced. The threshold may be a value different from the threshold of the inner product for the specified vector of AU, and may be determined for each subject based on the position of each marker during the expressionless state.

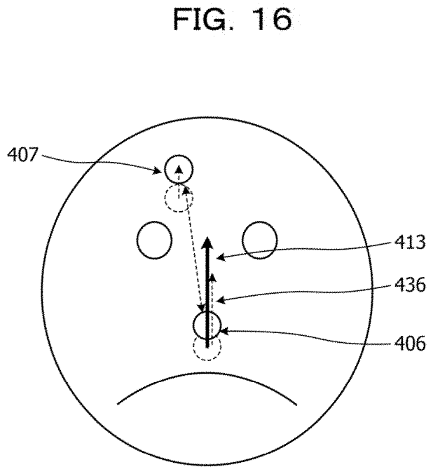

Next, an example in a case of canceling the occurrence of the AU09 will be described, FIG. 16 is a diagram illustrating an example of a movement vector when the occurrence of the AU09 is cancelled according to the present embodiment. The example of FIG. 16 illustrates the movement of the marker 406 associated with the AU09 and the other marker 407 when the subject makes a surprised facial expression. When the subject has a surprised facial expression, the correct determination result is that the AU09 has not occurred.

First, in the example of FIG. 16, again, since the inner product 436 of the specified vector 413 and a movement vector generated by the movement of the marker 406 is equal to or greater than the predetermined threshold, the determination unit 143 determines that the AU09 has occurred. However, as the marker 406 moves, the distance between the markers 406 and 407 is increased or does not change as compared with that during the expressionless state, and thus the determination unit 143 determines that the AU09 has not occurred. The determination of the distance between the markers here may also be performed using a predetermined threshold.

Referring back to FIG. 10, the generation unit 144 creates a data set in which a group of taken images and respective AU occurrence intensity are associated with each other. By performing machine learning using the data set, an AU occurrence intensity estimation model 132 is generated, which is a machine learning model for calculating an estimated value of an AU occurrence intensity from a taken image. The generation unit 144 removes markers from the group of taken images by image processing.

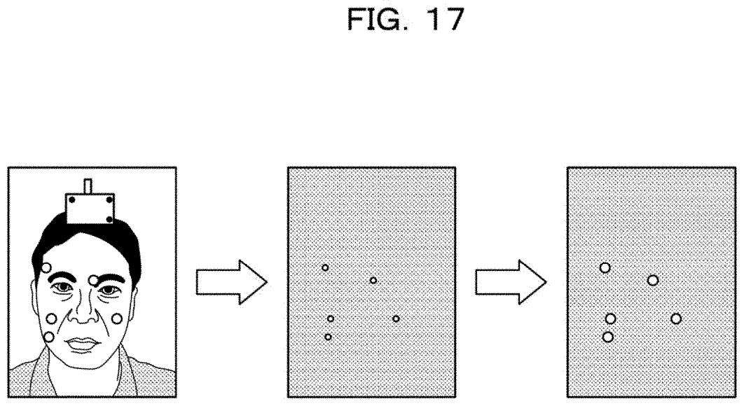

The generation unit 144 may remove the markers by using a mask image. FIG. 17 is an explanatory diagram illustrating a method of generating a mask image for removing markers according to the present embodiment. FIG. 17 illustrates on the left an image taken by the RGB camera 31. First, the generation unit 144 extracts the color of a marker intentionally attached and defines the color as a representative color. As illustrated in the middle of FIG. 17, the generation unit 144 generates a region image having a color close to the representative color. As illustrated on the right of FIG. 17, the generation unit 144 performs processing such as contraction and expansion on the region image to generate a mask image for marker removal. The marker color extraction accuracy may be improved by setting the marker color to a color that is less likely to be a face color.

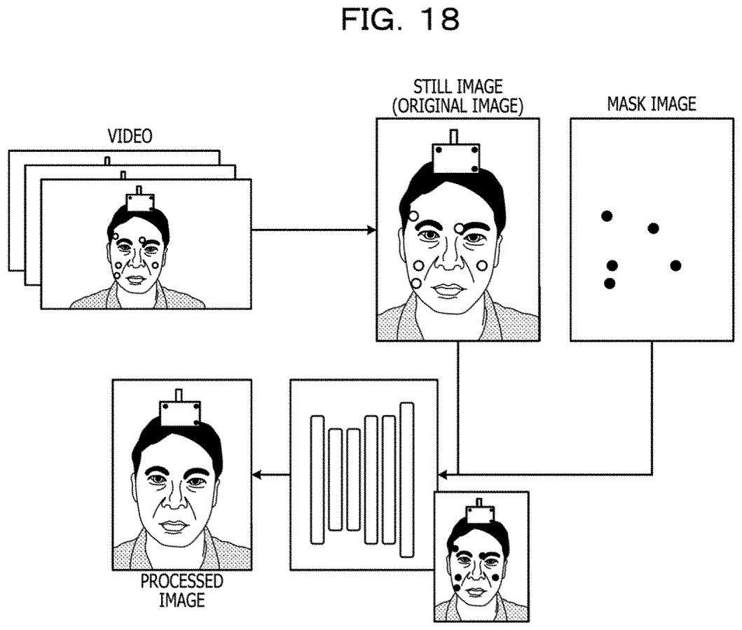

FIG. 18 is an explanatory diagram illustrating a method of removing markers according to the present embodiment. As illustrated in FIG. 18, first, the generation unit 144 applies a mask image to a still image acquired from a video. The generation unit 144 inputs the image with the mask image applied thereto to a neural network, for example, to obtain a processed image. It is assumed that the neural network has been trained using a masked image of the subject and an image without the mask. By acquiring still images from a video, there are advantages that data on facial expressions going through changes may be obtained and a large amount of data may be obtained in a short time. As the neural network, a generative multi-column convolutional neural networks (GMCNN) or generative adversarial networks (GAN) may be used.

The method of removing the markers by the generation unit 144 is not limited to that described above. For example, the generation unit 144 may generate a mask image by detecting the position of a marker based on a specified shape of the marker. The relative positions of the IR camera 32 and the RGB camera 31 may be calibrated in advance. In this case, the generation unit 144 may detect the position of the marker based on information of marker tracking by the IR camera 32.

The generation unit 144 may adopt different detection methods depending on the marker. For example, since a marker on the nose has little movement and a shape thereof is easy to be recognized, the generation unit 144 may detect the position by shape recognition. Since the marker on the side of the mouth has a large movement and a shape thereof is hard to be recognized, the generation unit 144 may detect the position using a method of extracting the representative color.

### Processing Flow

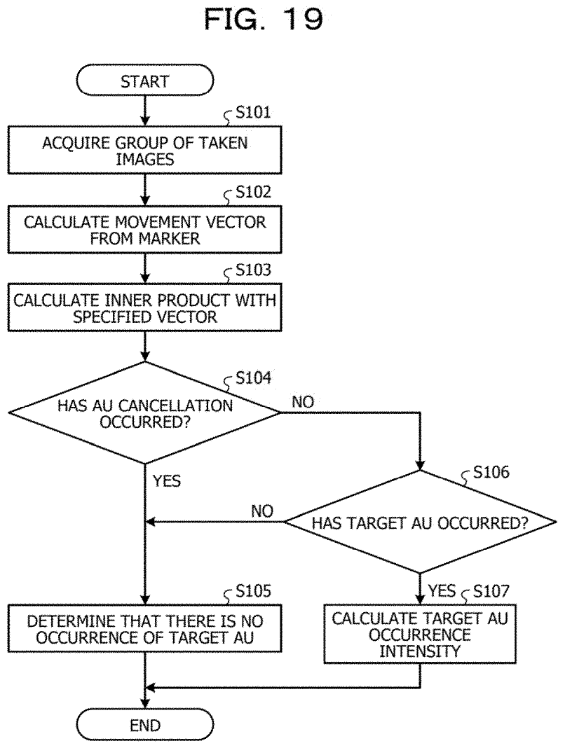

Next, with reference to FIG. 19, a flow of determination processing of AU occurrence intensity by the determination device 10 will be described. FIG. 19 is a flowchart illustrating an example of the flow of determination processing according to the present embodiment.

As illustrated in FIG. 19, first, the determination device 10 acquires a group of taken images including the face of a subject with a marker attached at each reference position corresponding to each of a plurality of AUs (step S101).

Next, the determination device 10 calculates a movement vector based on the position of the marker included in the taken image acquired in step S101 (step S102).

Then, the determination device 10 calculates an inner product of the movement vector acquired in step S102 and a specified vector corresponding thereto (step S103). The calculation of the inner product is executed for each AU.

Thereafter, the determination device 10 determines cancellation of the AU occurrence (step S104). As for the determination of the cancellation of AU occurrence, as described with reference to FIGS. 12 to 14, it is determined whether or not the inner product of a movement vector of a cancel marker corresponding to the AU determined to have occurred and the cancel vector, for example, is equal to or greater than a predetermined threshold. Alternatively, as described with reference to FIGS. 15 and 16, it is determined whether or not a distance between a marker that substantially moves when the AU determined to have occurred has actually occurred and another marker, for example, is less than a predetermined threshold.

When it is determined that the AU occurrence is cancelled (step S104: Yes), the determination device 10 determines that no target AU has occurred (step S105). After the execution of step S105, the determination processing illustrated in FIG. 19 is terminated.

On the other hand, when it is determined that the AU occurrence is not cancelled (step S104: No), it is determined whether or not the target AU has occurred based on the inner product calculated in step S103 (step S106). When it is determined that no target AU has occurred since the inner product calculated in step S103 is less than the predetermined threshold (step S106: No), the determination device 10 determines that no target AU has occurred (step S105), and the determination processing illustrated in FIG. 19 is terminated. The determination as to whether or not the target AU has occurred may be performed prior to the determination as to the cancellation of the AU occurrence in step S104. In this case, when it is determined that the target AU has occurred, determination as to the cancellation of the AU occurrence may be made.

On the other hand, when it is determined that the target AU has occurred (step S106: Yes), the determination device 10 calculates the occurrence intensity of the target AU based on the inner product calculated in step S103 (step S107), The calculation of the AU occurrence intensity in step S107 may be executed based on the distance between markers instead of the inner product. After the execution of step S107, the determination processing illustrated in FIG. 19 is terminated.

### Advantageous Effects

As described above, the determination device 10 acquires a taken image including a face with a plurality of markers attached. The determination device 10 determines whether a movement amount of a first marker, among the plurality of markers, in a first direction is equal to or greater than a first threshold, based on a first position of the first marker in the taken image and criteria for an occurrence state of a first facial muscle movement. The determination device 10 determines whether a movement amount of a second marker, among the plurality of markers, in a second direction is less than a second threshold, based on a second position of the second marker in the taken image and the criteria for the occurrence state of the first facial muscle movement. The determination device 10 determines that there is occurrence as to an occurrence state of the first facial muscle movement upon determining that the movement amount of the first marker in the first direction is equal to or greater than the first threshold and the movement amount of the second marker in the second direction is less than the second threshold. The determination device 10 determines that there is no occurrence as to the occurrence state of the first facial muscle movement upon determining that the movement amount of the first marker in the first direction is equal to or greater than the first threshold and the movement amount of the second marker in the second direction is equal to or greater than the second threshold.

Thus, even when it is difficult to perform adequate detection of a target AU only by the determination based on the movement of the marker that substantially moves when the target AU has occurred, the determination device 10 may perform more accurate facial expression determination based on the face image.

In the processing of determining that there is occurrence as to the occurrence state of the first facial muscle movement, the determination device 10 determines an occurrence intensity for the occurrence state of the first facial muscle movement, based on the movement amount of the first marker in the first direction.

Thus, the determination device 10 may perform more accurate facial expression determination based on the face image.

The determination device 10 generates training data for machine learning based on an image obtained by removing the first marker and the second marker from the taken image and on the occurrence intensity.

Thus, the determination device 10 may generate the training data for a machine learning model that enables more accurate facial expression determination based on the face image.

In the processing of determining that there is no occurrence as to the occurrence state of the first facial muscle movement, the determination device 10 determines the occurrence intensity for the occurrence state of the first facial muscle movement to be a value corresponding to no occurrence upon determining that there is no occurrence as to the occurrence state of the first facial muscle movement.

Thus, the determination device 10 may perform more accurate facial expression determination based on the face image.

The determination device 10 further determines whether a movement amount of a third marker, among the plurality of markers, in a third direction is equal to or greater than a third threshold, based on a third position of the third marker in the taken image and criteria for an occurrence state of a second facial muscle movement. The determination device 10 determines whether a movement amount of a fourth marker, among the plurality of markers, in a fourth direction is equal to or greater than a fourth threshold, based on a fourth position of the fourth marker in the taken image and the criteria for the occurrence state of the second facial muscle movement. The determination device 10 determines that there is occurrence as to an occurrence state of the second facial muscle movement upon determining that the movement amount of the third marker in the third direction is equal to or greater than the third threshold and the movement amount of the fourth marker in the fourth direction is equal to or greater than the fourth threshold. The determination device 10 determines an occurrence intensity for the occurrence state of the second facial muscle movement based on only the movement amount of the third marker in the third direction among the movement amount of the third marker in the third direction and the movement amount of the fourth marker in the fourth direction.

Thus, the determination device 10 may perform more accurate facial expression determination based on the face image.

The determination device 10 determines whether or not there is the facial muscle movement, based on a distance between the third marker and the fourth marker among the plurality of markers.

Thus, even when it is difficult to perform adequate detection of a target AU only by the determination based on the movement of the marker that substantially moves when the target AU has occurred, the determination device 10 may perform more accurate facial expression determination based on the face image.

The determination device 10 determines the first threshold and the second threshold based on the positions of the plurality of markers when the face is expressionless.

Thus, even for subjects having different face sizes, the determination device 10 may perform more accurate facial expression determination based on the face image.

### System

Unless otherwise specified, processing procedures, control procedures, specific names, and information including various types of data and parameters described above in this document or drawings may be arbitrarily changed. The specific examples, distributions, numerical values, and so forth described in the embodiment are merely exemplary and may be arbitrarily changed.

The specific form of distribution or integration of units included in each apparatus is not limited to that illustrated in the drawings. For example, the calculation unit 142 of the determination device 10 may be distributed to a plurality of processing units, or the calculation unit 142 and the determination unit 143 of the determination device 10 may be integrated into one processing unit. For example, all or part of the units may be configured so as to be functionally or physically distributed or integrated in arbitrary units in accordance with various types of loads, usage states, or the like. All or an arbitrary part of the processing functions performed by each apparatus may be implemented by a central processing unit (CPU) and a program analyzed and executed by the CPU or may be implemented by hardware using wired logic.

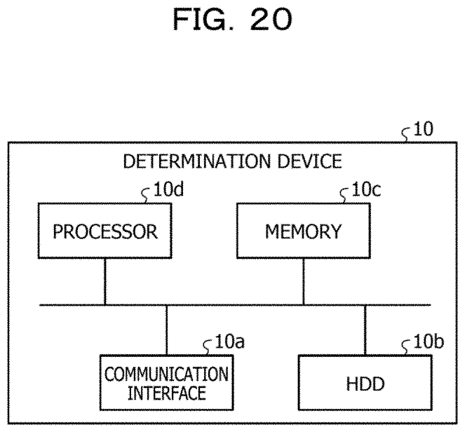

FIG. 20 is a diagram illustrating a hardware configuration example of the determination device according to the present embodiment. As illustrated in FIG. 20, the determination device 10 is a computer (information processing apparatus) including a communication interface 10a, a hard disk drive (HDD) 10b, a memory 10c, and a processor 10d. The components illustrated in FIG. 15 are coupled to each other by a bus or the like.

The communication interface 10a is a network interface card or the like and performs communication with other servers. The HDD 10b stores a program or DB that operates the functions illustrated in FIG. 9 and the like.

The processor 10d is the CPU, a microprocessor unit (MPU), a graphics processing unit (GPU), or the like. Alternatively, the processor 10d may be implemented by an integrated circuit such as an application-specific integrated circuit (ASIC) or a field-programmable gate array (FPGA). The processor 10d is a hardware circuit that reads, from the HdD 10b or the like, the program for executing processes similar to those of the processing units illustrated in FIG. 9 or the like, and loads the program to the memory 10c to operate processes of executing each of the functions illustrated in FIG. 10 or the like.

The determination device 10 may also implement the functions similar to the functions of the above-described embodiment by reading out the above-described programs from a recording medium with a medium reading device and executing the above-described read programs. The programs described in other embodiments are not limited to the programs to be executed by the determination device 10, For example, the above-described embodiment may be similarly applied when another computer or a server executes the program or the other computer and the server cooperate with each other to execute the program.

The programs may be distributed over a network such as the Internet. The program may be recorded on a computer-readable recording medium such as a hard disk, a flexible disk (FD), a compact disc read-only memory (CD-ROM), a magneto-optical (MO) disk, or a Digital Versatile Disc (DVD) and may be executed by being read from the recording medium by the computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a program causing a computer to execute a process, the process comprising:
acquiring a taken image including a face with a plurality of markers attached;
determining whether a movement amount of a first marker, among the plurality of markers, in a first direction is equal to or greater than a first threshold, based on a first position of the first marker in the taken image and criteria for an occurrence state of a first facial muscle movement;
determining whether a movement amount of a second marker, among the plurality of markers, in a second direction is less than a second threshold, based on a second position of the second marker in the taken image and the criteria for the occurrence state of the first facial muscle movement;
determining that there is occurrence as to an occurrence state of the first facial muscle movement upon determining that the movement amount of the first marker in the first direction is equal to or greater than the first threshold and the movement amount of the second marker in the second direction is less than the second threshold; and
determining that there is no occurrence as to the occurrence state of the first facial muscle movement upon determining that the movement amount of the first marker in the first direction is equal to or greater than the first threshold and the movement amount of the second marker in the second direction is equal to or greater than the second threshold.

2. The non-transitory computer-readable recording medium according to claim 1, the process further comprising:
determining an occurrence intensity for the occurrence state of the first facial muscle movement, based on the movement amount of the first marker in the first direction.

3. The non-transitory computer-readable recording medium according to claim 2, the process further comprising:
generating training data for machine learning based on an image obtained by removing the first marker and second marker from the taken image and on the occurrence intensity.

4. The non-transitory computer-readable recording medium according to claim 1, the process further comprising:
determining the occurrence intensity for the occurrence state of the first facial muscle movement to be a value corresponding to no occurrence upon determining that there is no occurrence as to the occurrence state of the first facial muscle movement.

5. The non-transitory computer-readable recording medium according to claim 1, the process further comprising:
determining whether a movement amount of a third marker, among the plurality of markers, in a third direction is equal to or greater than a third threshold, based on a third position of the third marker in the taken image and criteria for an occurrence state of a second facial muscle movement;
determining whether a movement amount of a fourth marker, among the plurality of markers, in a fourth direction is equal to or greater than a fourth threshold, based on a fourth position of the fourth marker in the taken image and the criteria for the occurrence state of the second facial muscle movement;
determining that there is occurrence as to an occurrence state of the second facial muscle movement upon determining that the movement amount of the third marker in the third direction is equal to or greater than the third threshold and the movement amount of the fourth marker in the fourth direction is equal to or greater than the fourth threshold; and
determining an occurrence intensity for the occurrence state of the second facial muscle movement based on only the movement amount of the third marker in the third direction among the movement amount of the third marker in the third direction and the movement amount of the fourth marker in the fourth direction.

6. The non-transitory computer-readable recording medium according to claim 1, the process further comprising:
determining whether there is occurrence as to the occurrence state of the first facial muscle movement, based on a distance between a third marker and a fourth marker among the plurality of markers.

7. The non-transitory computer-readable recording medium according to claim 1, the process further comprising:
determining the first threshold and the second threshold based on the positions of the plurality of markers when the face is expressionless.

8. An information processing apparatus, comprising:
a memory; and
a processor coupled to the memory and the processor configured to:
acquire a taken image including a face with a plurality of markers attached;
determine whether a movement amount of a first marker, among the plurality of markers, in a first direction is equal to or greater than a first threshold, based on a first position of the first marker in the taken image and criteria for an occurrence state of a first facial muscle movement;
determine whether a movement amount of a second marker, among the plurality of markers, in a second direction is less than a second threshold based on a second position of the second marker in the taken image and the criteria for the occurrence state of the first facial muscle movement;
determine that there is occurrence as to an occurrence state of the first facial muscle movement upon determining that the movement amount of the first marker in the first direction is equal to or greater than the first threshold and the movement amount of the second marker in the second direction is less than the second threshold; and
determine that there is no occurrence as to the occurrence state of the first facial muscle movement upon determining that the movement amount of the first marker in the first direction is equal to or greater than the first threshold and the movement amount of the second marker in the second direction is equal to or greater than the second threshold.

9. The information processing apparatus according to claim 8, wherein
the processor is further configured to:
determine an occurrence intensity for the occurrence state of the first facial muscle movement, based on the movement amount of the first marker in the first direction.

10. The information processing apparatus according to claim 9, wherein
the processor is further configured to:
generate training data for machine learning based on an image obtained by removing the first marker and second marker from the taken image and on the occurrence intensity.

11. The information processing apparatus according to claim 8, wherein
the processor is further configured to:
determine the occurrence intensity for the occurrence state of the first facial muscle movement to be a value corresponding to no occurrence upon determining that there is no occurrence as to the occurrence state of the first facial muscle movement.

12. The information processing apparatus according to claim 8, wherein
the processor is further configured to:
determine whether a movement amount of a third marker, among the plurality of markers, in a third direction is equal to or greater than a third threshold, based on a third position of the third marker in the taken image aid criteria for an occurrence state of a second facial muscle movement;
determine whether a movement amount of a fourth marker, among the plurality of markers, in a fourth direction is equal to or greater than a fourth threshold, based on a fourth position of the fourth marker in the taken image and the criteria for the occurrence state of the second facial muscle movement;
determine that there is occurrence as to an occurrence state of the second facial muscle movement upon determining that the movement amount of the third marker in the third direction is equal to or greater than the third threshold and the movement amount of the fourth marker in the fourth direction is equal to or greater than the fourth threshold; and
determine an occurrence intensity for the occurrence state of the second facial muscle movement based on only the movement amount of the third marker in the third direction among the movement amount of the third marker in the third direction and the movement amount of the fourth marker in the fourth direction.

13. The information processing apparatus according to claim 8, wherein
the processor is further configured to:
determine whether there is occurrence as to the occurrence state of the first facial muscle movement, based on a distance between a third marker and a fourth marker among the plurality of markers.

14. The information processing apparatus according to claim 8, wherein
the processor is further configured to:
determine the first threshold and the second threshold based on the positions of the plurality of markers when the face is expressionless.

15. A facial expression determination method, comprising:
acquiring, by a computer, a taken image including a face with a plurality of markers attached;
determining whether a movement amount of a first marker, among the plurality of markers, in a first direction is equal to or greater than a first threshold, based on a first position of the first marker in the taken image and criteria for an occurrence state of a first facial muscle movement;
determining whether a movement amount of a second marker, among the plurality of markers, in a second direction is less than a second threshold, based on a second position of the second marker in the taken image and the criteria for the occurrence state of the first facial muscle movement;
determining that there is occurrence as to an occurrence state of the first facial muscle movement upon determining that the movement amount of the first marker in the first direction is equal to or greater than the first threshold and the movement amount of the second marker in the second direction is less than the second threshold; and
determining that there is no occurrence as to the occurrence state of the first facial muscle movement upon determining that the movement amount of the first marker in the first direction is equal to or greater than the first threshold and the movement amount of the second marker in the second direction is equal to or greater than the second threshold.

16. The facial expression determination method according to claim 15, further comprising:
determining an occurrence intensity for the occurrence state of the first facial muscle movement, based on the movement amount of the first marker in the first direction.

17. The facial expression determination method according to claim 16, further comprising:
generating training data for machine learning based on an image obtained by removing the first marker and second marker from the taken image and on the occurrence intensity.

18. The facial expression determination method according to claim 15, further comprising:
determining the occurrence intensity for the occurrence state of the first facial muscle movement to be a value corresponding to no occurrence upon determining that there is no occurrence as to the occurrence state of the first facial muscle movement.

19. The facial expression determination method according to claim 15, further comprising:
determining whether a movement amount of a third marker, among the plurality of markers, in a third direction is equal to or greater than a third threshold, based on a third position of the third marker in the taken image and criteria for an occurrence state of a second facial muscle movement;
determining whether a movement amount of a fourth marker, among the plurality of markers, in a fourth direction is equal to or greater than a fourth threshold, based on a fourth position of the fourth marker in the taken image and the criteria for the occurrence state of the second facial muscle movement;
determining that there is occurrence as to an occurrence state of the second facial muscle movement upon determining that the movement amount of the third marker in the third direction is equal to or greater than the third threshold and the movement amount of the fourth marker in the fourth direction is equal to or greater than the fourth threshold; and
determining an occurrence intensity for the occurrence state of the second facial muscle movement based on only the movement amount of the third marker in the third direction among the movement amount of the third marker in the third direction and the movement amount of the fourth marker in the fourth direction.

20. The facial expression determination method according to claim 15, further comprising:
determining whether there is occurrence as to the occurrence state of the first facial muscle movement, based on a distance between a third marker and a fourth marker among the plurality of markers.
